(19) United States
(12) Patent Application Publication
(10) Pub. No.: US 2009/0024965 A1
(43) Pub. Date: Jan. 22, 2009

(54) GRAPHICAL METHOD OF SEMANTIC ORIENTED MODEL ANALYSIS AND TRANSFORMATION DESIGN

(76) Inventors: Aleksandr Zhdankin, Indialantic, FL (US); Eduard Babkin, Nizhny Novgorod (RU)

Correspondence Address: Zhdankin Aleksandr Vladimirovich, 215 Ormond Ave., Indialantic, FL, 32903, US

(21) Appl. No.: 11/781,250

(22) Filed: Jul. 21, 2007

(51) Int. Cl. G06F 3/01

(52) U.S. Cl. 715/863

(57) ABSTRACT

User is given the new modeling capability, a Semantic Lasso, which allows grouping of the model elements, so they can be mapped or transformed to the high-level concepts of business ontology. Such grouping is done by drawing of the line contour around relevant to advertised high-level concept model elements on one of the OMG Unified Modeling Language (UML) class diagrams. In addition the user is given a capability to specify extension points of the high-level concepts and the projection of such extension points to the individual model. Another tooling capability, a Semantic Transformation Lens, allows dynamic graphical projection of the individual model fragments to the high-level concepts as those elements are being selected. Semantic Transformation Lens provides the mechanism of reasoning-based smart selection.

### FIELD OF THE INVENTION

The present invention relates in general to the field of knowledge modeling and information transformation and is particularly directed to a semantic-oriented model analysis, translation or mapping methodology and graphical methods of model mapping design.

### BACKGROUND OF THE INVENTION

In many areas of knowledge and information management it is necessary to provide interoperability between various systems, which are using different information and data models to describe semantically equivalent things. In order to perform integration quickly and with lower cost, different models need to be analyzed from the perspective of semantic similarities and differences and the mappings or translation rules need to be specified accordingly. Traditionally, model comparison, is performed on the class-by-class and relationship-by-relationship basis in the object-oriented terms. However, such methodology, even if it works some time, does not provide fair comparison, since the granularity and the meaning of classes and relationships in different models can be different and depends on the requirements that existed at the time of model creation and the level of abstraction each model follows.

In order to create the mapping and implement the transformations between different models correctly the mapping should be done at the higher levels of abstractions, at the level of concept entities. It is possible to identify the same concepts that are represented by several models and render the definition of these concepts to the modeling constructs specific to individual models.

FIG. 1 illustrates the approach descried above. A set of high-level concepts 101 is rendered to 3 different models 102, 103 and 104 using modeling constructs specific to each individual model. Based on these renderings the mapping and transformation rules 105 can be defined between each pair of the models. In the context of systems' interactions within the particular business scenario such high-level concepts can be treated as conversation topics, around which relevant model structures are built. By going through each model it is possible to identify different flavors of the particular concepts—which were specified previously by the creators of the model and find the match for these flavors in the other model by looking at properties/qualities of each relevant model entity.

In accordance with this approach, the deterministic model mapping process can be defined. First, a business process, which provides the context of systems interactions, needs to be determined. High-level concepts and different aspects of these concepts, aligned with abovementioned processes need to be defined next. For each model necessary and sufficient elements representing the particular concept are selected. Then it is possible to go through each model and identify different flavors of the particular concepts and try to find the match for these flavors in the other models. The process follows from the very generic semantic concepts to the particular areas in the model, and then areas may reveal intricate details specific to the particular model, which may or may not be mapped to other models.

One of the key elements of this process is the ability to identify generic rules of how different concepts are rendered and to determine whether these rules can be formalized. This is done initially via manual process of structural mapping to the identified concepts. Based on the complexity of the model the depth and breadth of required mapping may be different.

One should be able to infer general mapping rules based on the results of the mapping done manually. Also it should be possible to perform structural mapping between models automatically using the mappings of individual models to the high-level concepts.

Once the base mappings are complete the “intelligent” model analysis and real-time model discovery and mapping can be performed in automated or semi-automated fashion.

Such complex and iterative process requires appropriate tools that would allow user to analyze the model and understand its building principles and intricate characteristics in order to design transformations and mappings between various models. Traditional tools that are oriented on the straight linear mapping of classes, their attributes and operation do not provide such capabilities and are mostly oriented at the implementation of such transformations. Besides, the paradigm they are based on requires the transformation rules to be defined manually and completely and thus they do not leave room for reasoning and automated creation of complex transformations.

### SUMMARY OF THE INVENTION

In accordance with the present invention, user is given the new tooling capability, otherwise known as SL (Semantic Lasso), which allows grouping of the model elements, so they can be mapped or transformed to the high-level concepts of business ontology. Such grouping is done via simple graphical selection of groups of model elements, such as classes and associations in the object-oriented terms and assigning selected groups to the high-level modeling abstractions, otherwise known as high-level business concepts.

Selection can be performed either by drawing the line contour around relevant to advertised high-level concept model elements on one of the OMG Unified Modeling Language (UML) class diagrams associated with the model being analyzed, or by simple mechanism of multi-selection, which is standard capability to most of the modern Graphical User Interface (GUI) based applications. Line contour or multi-selection visually groups relevant element together. Once selection is performed the user may choose whether the new high-level concept or the concept's aspect needs to be created based on selection, or the selected group can be associated with one of the existing high-level entities.

If selection is performed by drawing the contour on the diagram, the contour does not necessary has to be closed. User may want to leave the contour open. In this case the design application will determine how to complete selection automatically. For example, user may select just relevant classes and the system will make a decision to what other relationships need to be selected in order to complete the definition of the high-level concept.

Another tooling capability that is a part of the present invention, otherwise known as Semantic Transformation Lens (SETRAL), allows dynamic graphical projection of the individual model fragments to the high-level concepts as model elements are being selected. This capability can be applied to the models after the analysis phase, when the high-level concepts are created and defined via the mechanism of Semantic Lasso described earlier.

Similarly to the Semantic Lasso, application of the Semantic Transformation Lens does not require for all the elements of the analyzed model to be selected by user. SETRAL provides the mechanism of auto-selection or smart selection, when certain non-selected model entities (classes and relationships) are associated with the complete selection-to-be automatically and the user gets the high-level concepts view of the model based on that automatic decision making process.

As the user builds the library of high-level concepts and the relevant model projections by grouping the model elements using Semantic Lasso, he/she is given a capability to specify extension points of the high-level concepts and the projection of such extension points to the individual model. The extension point is a specification, which describes how the traditional for the object-oriented modeling concept of class extension is applicable to the particular high-level concept and how such extension affects elements of the model being mapped. For example, the extension of the high-level concept may imply the extension of one of the classes of the concept projection, or it may imply that another class from the projected model needs to be added to the extended specification. According to this invention the extension points can be specified via but not limited to the use of Object Management Group (OMG) Object Constraints Language (OCL) constructs.

### BRIEF DESCRIPTION OF THE DRAWINGS

FIG. 1 shows an approach to the model mapping, when mapping of the different models to each other is done via individual mappings of each model to the set of common semantic concepts;

FIG. 2 diagrammatically illustrates the concept of Semantic Lasso;

FIG. 3 introduces the concept of Semantic Transformation Lens and explains its auto-complete feature; and

FIG. 4 diagrammatically illustrates application of the Semantic Transformation Lens to the class-level model.

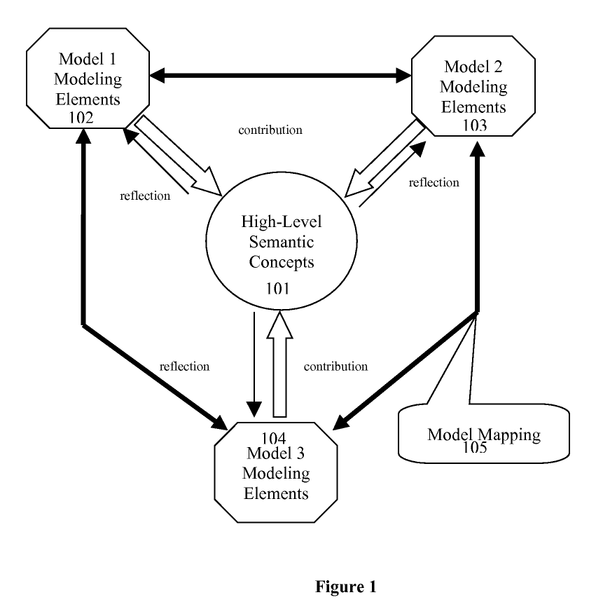

### DETAILED DESCRIPTION

Before describing the methodology for semantic-based model analysis and design in accordance with the present invention, it should be observed that the invention resides primarily in prescribed methodology of graphical selection of class and object diagram elements of UML model, association of selected elements with high-level concepts or elements of semantically overlapping models and dynamic graphical projection of the individual model fragments to the high-level concepts and other model fragments as those elements are being selected in case if previously established mapping exists, that have been shown in the drawings, which show only those specific aspects that are pertinent to the present invention, so as not to obscure the disclosure with details which will be readily apparent to those skilled in the art having the benefit of the description herein. Thus, the diagrams are primarily intended to show the major components and principles of a preferred embodiment of the invention in convenient functional groupings, whereby the present invention may be more readily understood.

As pointed out briefly above, user is given the new tooling capability, otherwise known as Semantic Lasso, which allows grouping of the model elements, so they can be mapped or transformed to the high-level concepts of business ontology. The grouping is done via graphical selection of classes and associations as model elements in the object-oriented terms and assigning selected elements to the high-level modeling abstractions, otherwise known as high-level business concepts. To select, the user draws the line contour of arbitrary shape around relevant to advertised high-level concept model elements on one of the OMG Unified Modeling Language (UML) class diagrams associated with the model being mapped, which visually groups relevant model element together. Flexible form of selection shape gives the ability to represent mapping in a more flexible way, since the arbitrary form of the shape does not impose mental restrictions.

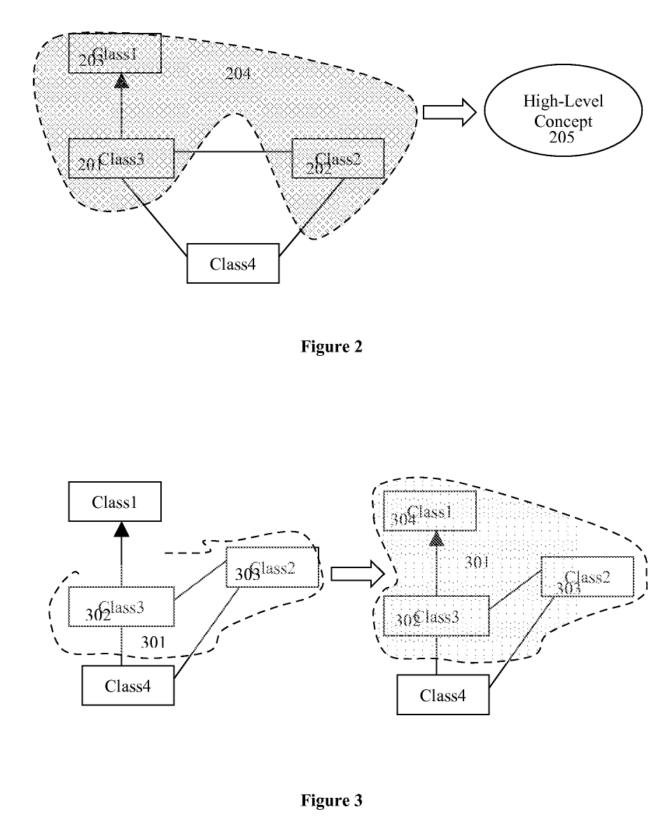

The process of selection is illustrated by FIG. 2, wherein related model elements 201, 202 and 203 are surrounded by the contour of Semantic Lasso 204. The interior area of selection is color-filled and semi-transparent.

Once selection is complete, selected group of elements can be mapped to the high-level business concept 205 by selecting one of the existing concepts from the list, or the new concept, associated with selected group can be created.

Information about selection and association of the group of selected model elements with high-level concepts is stored persistently and can be used later on for applications of Semantic Transformation Lens (SETRAL). Semantic Transformation Lens allows display of dynamic graphical projection of the individual model fragments to the high-level concepts as those elements are being selected.

Selection process is very similar to the application of Semantic Lasso. It is done by drawing arbitrary contour around groups of UML model elements. As user performs the selection, system suggests and auto-completes selection based on the existing mappings to the high-level concepts by automatic selection of additional elements. FIG. 3 illustrates this process.

Initially the group of classes 302, 303 and 304 were associated with some high-level concept by using Semantic Lasso. User starts applying Semantic Transformation Lens 301 by selecting classes 302 and 303. System automatically completes the selection by adding class 304 since there is a mapping of the group 302, 303 and 304, but there is no mapping just for the classes 302 and 303 alone or together. The complete selection area is highlighted with color and becomes semi-transparent.

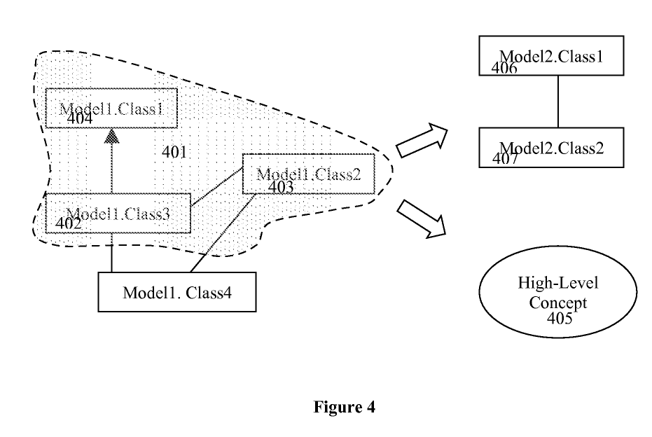

Once selection is complete, user can choose whether the lens will display the high-level concept the selected group of elements is mapped to or the relevant elements from one of the other models, provided that such fragments are mapped to the same high-level concept. As FIG. 4 illustrates, model elements 402, 403 and 404 selected using Semantic Transformation Lens 401 can be graphically mapped or transformed either into high-level concept 405 or group of associated classes from Model2-406 and 407.

While I have shown and described an embodiment in accordance with the present invention, it is to be understood that the same is not limited thereto but is susceptible to numerous changes and modifications as known to a person skilled in the art, and I therefore do not wish to be limited to the details shown and described herein, but intend to cover all such changes and modifications as are obvious to one of ordinary skill in the art.

What is claimed:

1. The graphical method of semantic-oriented model transformation design comprising the steps of:
(a) grouping of the UML model elements, so they can be mapped or transformed to the high-level concepts of business ontology by selecting the groups of model elements, such as classes and associations in the object-oriented terms using the new tooling capability named as Semantic Lasso;
(c) assigning selected groups to the high-level modeling abstractions, otherwise known as high-level business concepts.

2. The selection method according to claim 1 wherein step (a) can be performed:
(a) by drawing of the arbitrary line contour around relevant to advertised high-level concept model elements on one of the OMG Unified Modeling Language (UML) class diagrams associated with the model being transformed;
(b) by simple mechanism of multi-selection, which is standard capability to most of the modern Graphical User Interface (GUI) based applications.

3. The selection method according to claim 2 wherein selection is performed in accordance with step (a) the contour does not necessary has to be closed. The contour may be left open in order for the design application to determine how to complete selection automatically.

4. The method of specifying the extension points of the high-level concepts and the projection of such extension points to the individual model upon completion of selection in accordance with claim 1.

5. The graphical method of semantic-oriented model analysis, which can be applied to the models after the mapping phase, when the high-level concepts are created and assigned according to the claim 1 comprising the steps of:
(a) simple graphical selection of groups of model elements, such as classes and associations in the object-oriented terms using the new tooling capability named as Semantic Transformation Lens;
(b) dynamic graphical projection of the individual model fragments to the high-level concepts as those elements are being selected.

6. The selection method according to claim 4 wherein step (a) can be performed:
(a) by drawing of the arbitrary line contour around model elements on one of the OMG Unified Modeling Language (UML) class diagrams associated with the model being analyzed, which visually groups relevant model element together;
(b) by simple mechanism of multi-selection, which is standard capability to most of the modern Graphical User Interface (GUI) based applications.

7. The selection method according to claim 6 wherein selection is performed in accordance with step (a) the contour does not necessary has to be closed. The contour may be left open in order for the design application to determine how to complete selection automatically.
